(19) United States
(12) Patent Application Publication
(10) Pub. No.: US 2017/0276272 A1
(43) Pub. Date: Sep. 28, 2017

(54) GROMMET ATTACHMENT STRUCTURE AND GROMMET

(71) Applicant: Sumitomo Wiring Systems, Ltd., Yokkaichi (JP)

(72) Inventor: Hirokazu NAKAI, Yokkaichi (JP)

(21) Appl. No.: 15/453,462

(22) Filed: Mar. 8, 2017

(30) Foreign Application Priority Data
Mar. 25, 2016 (JP) 2016061296

(51) Int. Cl. F16L 21/08; F16L 25/00

(52) U.S. Cl. CPC F16L 21/08; F16L 25/0036

(57) ABSTRACT

A grommet attachment structure and a grommet that make it possible to stabilize the force for fixing the grommet to a component. The grommet includes a main body portion that is tubular, lip portions that project from the inner peripheral surface of the main body portion and can come into contact with the outer circumferential surfaces of components, and fold back portions that are provided at positions on the main body portion on end sides in the axial direction relative to the lip portions, and that cover the formation regions of the lip portions when folded back to the outer side.

This Application claims the benefit of Japanese Application No. JP2016-061296, filed on Mar. 25, 2016, the contents of which are hereby incorporated by reference in their entirety.

### FIELD

The present invention relates to a grommet attachment structure and a grommet.

### BACKGROUND

Conventionally, a grommet for attachment to the connection portion between two components is known. For example, JP 2016-9538A discloses a grommet for attachment to the connection portion between a metal pipe and a corrugated tube. One end side of the grommet is fitted around the pipe, the other end side is fitted around the corrugated tube, and the two end sides are fixed by being fastened with fastening bands.

However, in the above-described configuration, the force for fixing the grommet to the components is obtained by the fastening force of the fastening bands, and therefore there is a problem in that variation easily occurs in the fixing force. If the force for fixing the grommet to the components is too weak, there is concern of detachment, whereas if the force for fixing the grommet to the components is too strong, there is concern of crushing a component such as a corrugated tube, and therefore there is desire for a solution.

### SUMMARY

The present design was achieved in light of the above-described circumstances, and an object thereof is to provide a grommet attachment structure and a grommet that make it possible to stabilize the force for fixing the grommet to a component.

A grommet attachment structure according to one aspect is a grommet attachment structure in which an end portion of a grommet is fitted around and fixed to a component in a state of being folded back to an outer side.

A grommet according to another aspect includes: a main body portion that is tubular; a lip portion that projects from an inner peripheral surface of the main body portion and can come into contact with an outer circumferential surface of a component; and a fold back portion that is provided at a position on the main body portion on an end side in an axial direction relative to the lip portion, and covers a formation region of the lip portion when folded back to an outer side.

According to the grommet attachment structure of the present design, the end portion of the grommet is fixed to a component by the elastic force in the diameter shrinking direction of the fold back portion, thus making it possible to stabilize the force for fixing the grommet to the component.

According to the grommet of the present design, when the fold back portion is fixed to the component in the state of being folded back to the outer side, the grommet is fixed to the component by the elastic force in the diameter shrinking direction of the fold back portion, thus making it possible to stabilize the force for fixing the grommet to the component.

### DRAWINGS

FIG. 1 is a perspective view of a grommet according to an embodiment;

FIG. 2 is a cross-sectional view of the grommet;

FIG. 3 is a perspective view of the grommet in a state where end portions have been folded back; and

FIG. 4 is a cross-sectional view of the grommet in a state of being attached to a connection portion between two components.

### DESCRIPTION

Preferred embodiments of the present invention are described below.

The grommet may further include a thin portion formed at a fold back position of the fold back portion on the main body portion. According to this configuration, it is possible to suppress rounding and bulging in the fold back portion of the main body portion.

Also, the grommet may further include a locking portion that is provided on the fold back portion and is locked to an outer circumferential surface of the main body portion in a state of being folded back to the outer side. According to this configuration, the locking portion of the fold back portion is locked to the outer circumferential surface of the main body portion, thus making it possible to prevent the fold back portion from shifting in the folded back state.

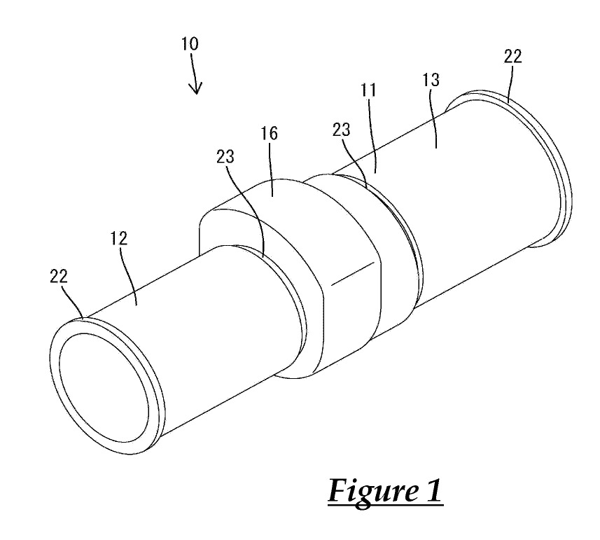

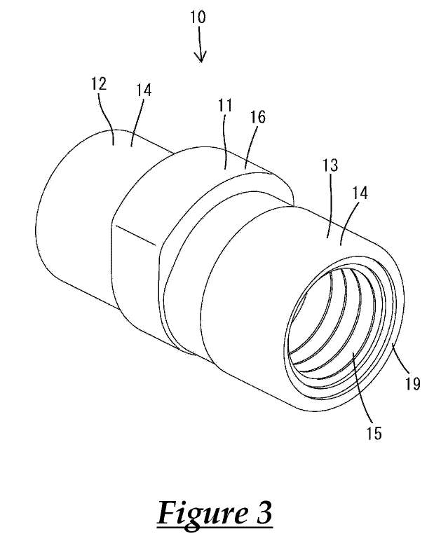

Hereinafter, an embodiment will be described in detail with reference to FIGS. 1 to 4.

A grommet 10 of the present embodiment is for attachment to the connection portion between two components. The present embodiment describes a case in which out of the two components, one of the components (referred to hereinafter as a first component P1) is a pipe made of a metal or a synthetic resin, and the other component (referred to hereinafter as a second component P2) is a corrugated tube that is shaped as a bellows having mountain portions and valley portion that are successively formed in an alternating manner in the axial direction. The first component P1 and the second component P2 surround a collection of multiple electrical wires W, and are cylindrical overall.

The grommet 10 is made of rubber, which is an elastic material, and includes a main body portion 11 that is tubular overall. One end side of the main body portion 11 in the axial direction is a first fitting portion 12 that is fitted around the first component P1, and the other end side is a second fitting portion 13 that can be fitted around the second component P2. A projection portion 16 that projects one level circumferentially outward is provided on the central portion of the main body portion 11 in the axial direction (the portion between the first fitting portion 12 and the second fitting portion 13).

The first fitting portion 12 and the second fitting portion 13 have an approximately circular cross-section and are capable of being fitted around the first component P1 and the second component P2 respectively. Note that the thickness of the second fitting portion 13 is greater than the thickness of the first fitting portion 12.

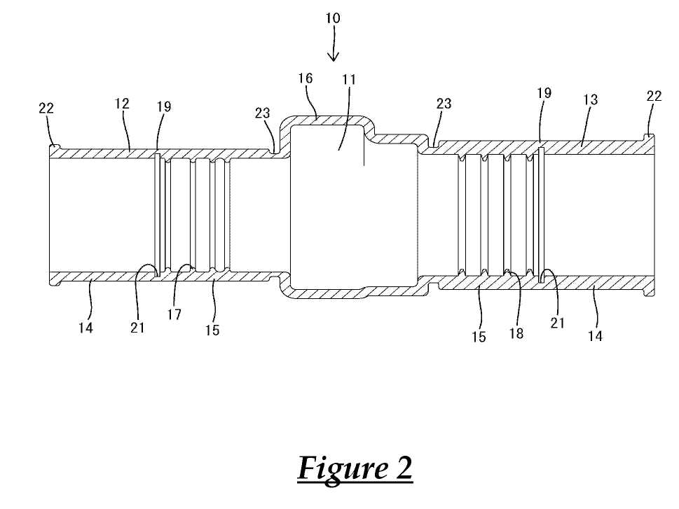

Portions of the first fitting portion 12 and the second fitting portion 13 that are located toward the ends of the main body portion 11 are fold back portions 14 that are folded back to the outer side, and the portions located toward the center of the main body portion 11 are inward portions 15 that are arranged inward of the fold back portion 14. The fold back portion 14 and the inward portion 15 have the same length in the axial direction and the same thickness (see FIG. 2).

First lip portions 17 and second lip portions 18 that can respectively come into contact with the outer circumferential surfaces of the first component P1 and the second component P2 protrude from the inner peripheral surfaces of the first fitting portion 12 and the second fitting portion 13 respectively. The first lip portions 17 and the second lip portions 18 are formed in a continuous manner over the entire circumference on the inner peripheral surfaces of the inward portions 15.

Multiple (four in the present embodiment) first lip portions 17 are provided, and are overall formed at positions biased toward the fold back portion 14 on the inward portion 15. The interval between adjacent first lip portions 17 is larger the closer the position is to the fold back portion 14. Multiple (four in the present embodiment) second lip portions 18 are provided, and the intervals between adjacent second lip portions 18 are the same.

A thin portion 19 is formed between each pair of a fold back portion 14 and inward portion 15. The thin portions 19 are formed at the boundary between each pair of an inward portion 15 and a fold back portion 14, that is to say at positions that bisect the first fitting portion 12 and the second fitting portion 13 in the axial direction. The thin portions 19 are fold back positions of the fold back portions 14.

The thin portions 19 are portions where the thickness of the main body portion 11 is smaller than that of the other portions due to the formation of groove portions 21 that extend in the circumferential direction of the main body portion 11. The groove portions 21 are formed in a continuous manner over the entire circumference on the inner peripheral surface side of the main body portion 11. The thickness of the thin portions 19 is approximately half the thickness of the first fitting portion 12 and the second fitting portion 13.

The fold back portions 14 are each provided with a locking portion 22 that is locked to the outer circumferential surface of the main body portion 11 when folded back to the outer side. The locking portions 22 project outward along the end edges of the fold back portions 14. The locking portions 22 are continuous over the entire circumference of the fold back portions 14. Note that the projection length of the locking portion 22 of the second fitting portion 13 is somewhat greater than the projecting length of the locking portion 22 of the first fitting portion 12.

Lock receiving portions 23, to which the locking portions 22 are to be locked, are provided on the outer circumferential surface of the main body portion 11. The lock receiving portions 23 have a cross-section that conforms to the locking portions 22, and are grooves that are recessed in the outer circumferential surface. The lock receiving portions 23 are continuous over the entire circumference of the main body portion 11. The lock receiving portions 23 are provided in the end portions of the inward portions 15, and are recessed along respective end surfaces of the projection portion 16 in the axial direction.

Next, one example of an operation for attaching the grommet 10 to the connection portion between the first component P1 and the second component P2 will be described.

First, the first fitting portion 12 and the second fitting portion 13, in which the fold back portions 14 have not been folded back, are fitted around the first component P1 and the second component P2 respectively. At this time, the first fitting portion 12 and the second fitting portion 13 are arranged at a depth at which the entirety of the inward portions 15 cover the first component P1 and the second component P2. Accordingly, the first lip portions 17 come into contact with the outer circumferential surface of the first component P1, and the second lip portions 18 enter the valley portions of the second component P2.

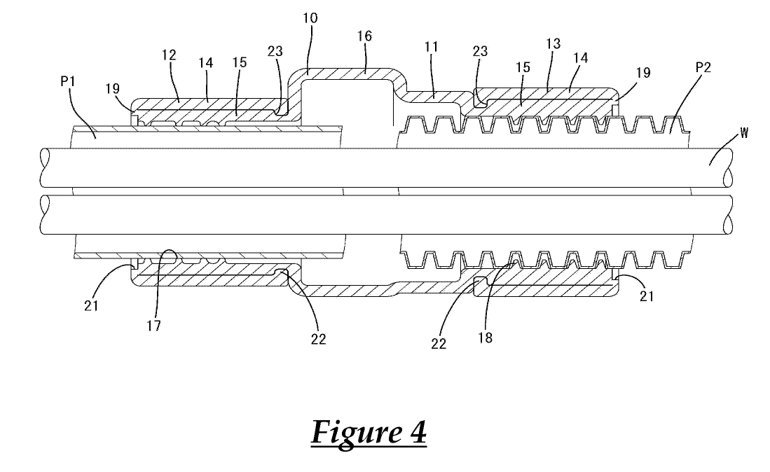

Next, the fold back portions 14 are folded back to the outer side. When the fold back portions 14 are folded back at the thin portions 19, as shown in FIG. 4, the fold back portions 14 are laid on the outer sides of the inward portions 15 (the formation regions of the first lip portions 17 and the second lip portions 18), and the locking portions 22 are fitted into and locked to the lock receiving portions 23. Elastic force in the diameter shrinking direction is generated in the fold back portions 14 that are folded back to the outer side, and the first fitting portion 12 and the second fitting portion 13 are respectively fixed to the first component P1 and the second component P2 by the elastic force of the fold back portions 14. At this time, due to the elastic force of the fold back portions 14, the first lip portions 17 are elastically pressed against and in close contact with the outer circumferential surface of the first component P1, and the inner peripheral surface of the inward portion 15 of the second fitting portion 13 is elastically pressed against and in close contact with the mountain portions of the second component P2.

As described above, the operation for attaching the grommet 10 to the connection portion between the first component P1 and the second component P2 is complete.

Next, actions and effects of the embodiment having the above-described configuration will be described.

According to the attachment structure of the grommet 10 of the present embodiment, the end portions of the grommet 10 are fitted around and fixed to the first component P1 and the second component P2 in the state of being folded back to the outer side. According to this configuration, the end portions of the grommet 10 are fixed to the first component P1 and the second component P2 by the elastic force in the diameter shrinking direction of the fold back portion 14, thus making it possible to stabilize the force for fixing the grommet 10 to the components.

Also, the grommet 10 of the present embodiment includes the main body portion 11 that is tubular, the first lip portions 17 and the second lip portions 18 that project from the inner peripheral surface of the main body portion 11 and can come into contact with the outer circumferential surfaces of the first component P1 and the second component P2, and fold back portions 14 that are provided at positions on the main body portion 11 on end sides in the axial direction relative to the first lip portions 17 and the second lip portions 18, and that cover the formation regions of the first lip portions 17 and the second lip portions 18 when folded back to the outer side. According to this configuration, the fold back portions 14 are fixed to the first component P1 and the second component P2 in the state of being folded back to the outer side, and therefore the grommet 10 can be fixed to the first component P1 and the second component P2 by the elastic force in the diameter shrinking direction of the fold back portions 14, thus making it possible to stabilize the force for fixing the grommet 10 to the components.

Also, the thin portions 19 are formed at fold back positions of the fold back portions 14 in the main body portion 11. According to this configuration, it is possible to suppress rounding and bulging in the fold back portions 14 of the main body portion 11.

Also, the fold back portions 14 are each provided with the locking portion 22 that is locked to the outer circumferential surface of the main body portion 11 when folded back to the outer side. According to this configuration, the locking portions 22 of the fold back portions 14 are locked to the outer circumferential surface of the main body portion 11, thus making it possible to prevent the fold back portions 14 from shifting in the folded back state.

The present invention is not intended to be limited to the embodiment described using the above descriptions and drawings, and embodiments such as the following examples are also encompassed in the technical scope of the present invention.

Although the fold back portion 14 is provided at each of the two end portions of the grommet 10 in the above embodiment, the present invention is not limited to this. The fold back portion may be provided at only one of the two end portions of the grommet, and a configuration is possible in which the fold back portion is provided on only the side that is fitted around the corrugated tube, and the side fitted around the pipe is firmly fastened by a fastening band, for example.

Although an example of the case of the first component P1 being a pipe and the second component P2 being a corrugated tube is described in the above embodiment, the present invention is not limited to this. The first component and the second component may be any component, such as one being a connector and the other being a corrugated tube, both components being corrugated tubes, or both components being pipes.

Although the thin portions 19 are portions that are thin due to the formation of the groove portions 21 in the main body portion 11 in the above embodiment, the present invention is not limited to this. For example, the thin portions may be formed by slits cut into the main body portion, or the thin portions may be severed when the fold back portions are folded back.

Although the locking portions 22 are formed in a continuous manner over the entire circumference in the above embodiment, the present invention is not limited to this, and multiple locking portions may be provided intermittently in the circumferential direction.

Although the locking portions 22 are provided along the end edges of the fold back portions 14 in the above embodiment, the present invention is not limited to this, and the locking portions may be provided in intermediate portions of the fold back portions, for example.

In the above embodiment, the locking portions 22 project from the outer circumferential surfaces of the fold back portions 14, and the lock receiving portions recede from the outer circumferential surface of the main body portion, but the present invention is not limited to this. A configuration is possible in which the locking portions are provided as recessions, and the lock receiving portions are provided as projections.

Although the grommet 10 is cylindrical overall in the above embodiment, the present invention is not limited to this, and the grommet 10 may be elliptical, rectangular, or the like.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### REFERENCE SIGNS LIST

P1: First component
P2: Second component
10: Grommet
11: Main body portion
14: Fold back portion
17: First lip portion
18: Second lip portion
19: Thin portion
22: Locking portion

1. A grommet, comprising:
a main body portion that is tubular;
a lip portion that projects from an inner peripheral surface of the main body portion and can come into contact with an outer circumferential surface of a component; and
a fold back portion that is provided at a position on the main body portion on an end side in an axial direction relative to the lip portion, and covers a formation region of the lip portion when folded back to an outer side.

2. The grommet according to claim 1, further comprising a thin portion formed at a fold back position of the fold back portion on the main body portion.

3. The grommet according to claim 1, further comprising a locking portion that is provided on the fold back portion and is locked to an outer circumferential surface of the main body portion in a state of being folded back to the outer side.

4. A grommet attachment structure, wherein an end portion of the grommet of claim 1 is fitted around and fixed to a component in a state of being folded back to an outer side.
